(19) United States
(12) Patent Application Publication
(10) Pub. No.: US 2005/0086859 A1
(43) Pub. Date: Apr. 28, 2005

(54) Folding support stand for plants

(76) Inventors: John Bruno, Parker, CO (US); Duane E. Goman, West Corvina, CA (US)

Correspondence Address: TIMOTHY J MARTIN, PC, 9250 W 5TH AVENUE, SUITE 200, LAKEWOOD, CO, 80226, US

(21) Appl. No.: 10/691,908

(22) Filed: Oct. 22, 2003

(51) Int. Cl. A01G 17/06; A01G 9/12

(52) U.S. Cl. 47/46

(57) ABSTRACT

A folding support stand is used to hold up growing plants. The stand has a pair of matching support frames each having a pair of legs interconnected by at least one beam member. The support frames are connected for pivotal movement between and open position for use and a closed position for storing, and a catch is provided to prevent this pivotal motion. Here the legs on each frame may form a scissor assembly with a leg on the other frame. At least one trellis piece is disposed on and supported by each support frame. In the embodiments, two beams and a plurality of trellis pieces are associated with each support frame. The trellis pieces can be slats or serpentine wire members. The catch can be variable so that the acute angle between the support frames can be changed, as desired.

### FIELD OF THE INVENTION

The present invention broadly concerns the field of horticulture. More particularly, the present invention relates to an apparatus to facilitate the growth of plants. Specifically, the present invention relates to the support of vines, climbing plants and the like. This invention thus particularly concerns gardening activities.

### BACKGROUND OF THE INVENTION

Since the early domestication of useful plants, humankind has sought improved ways to facilitate the growing, caring for and maintaining such plants. This concern has reached both food producing plants and ornamental plants. It is known that many such plants benefit from the availability of an upright framework proximate to the plant. For example, some plants grow with upright stalks having laterally projecting stems or branches extending therefrom. The weight of fruit or other growth structures such plants can stress the stalks and branches. Such stress can result in damage to the plant including breakage of the stalks or branches resulting even of the death of the plant. This problem has increased due to the hybridization of certain plants to produce heavier fruits.

In addition, it is known that some climbing plants enjoy a support framework of on which to proliferate. Predominate among such plants are vines which typically grow along ground level but are provided with tendrils that cling to structures for support. When an upright structure is available, these vines will cling to and crawl up the support structure or will intertwine around sections of the support structure. The availability of an upright support structure not only provides an environment upon which the plant may proliferate, but also helps maintain the fruits of such vines out of contact with the ground. Where the fruits are maintained off of the ground, they are less likely to become the target of crawling insects or other vermin. Likewise, the fruits of such plants may stay healthy for a longer duration.

While it is known to provide simple upright poles upon which some plants may be tied, more advanced structures have also been employed. Various fences, wire frameworks and the like have been used to provide an ensemble of wires upon which climbing vines may cling. Wire fences can either be a single strand of horizontal extending wires or a matrix of woven wires that provides a meshwork for such vines. Cage structures are generally shaped in a cylindrical tube or have an inverted frustoconical configuration.

While many of these existing structures are quite suitable for the care and maintenance of plants, they have certain drawbacks. On one hand, they are difficult to store when not in use. In addition, many of these supports are plain in appearance so that they tend to detract from the aesthetic appearance of a garden. Wire structures often become bent or mangled over the course of time which acts to decrease their aesthetic appeal as well as their utilitarian function. Some lightweight wire structures, on the other hand, do not have sufficient strength to support large plants with heavy fruits.

Accordingly, there is a need for support structures for plants that may be easily stored yet are simple to erect. There is also a need for support structures for plants that are sturdy in construction so as to provide substantial support for a plant yet which remain aesthetically pleasing. The present invention addresses these needs.

### SUMMARY OF THE INVENTION

It is an object of the present invention to provide a new and useful support stand for growing plants.

Another object of the present invention is to provide a support stand for plants which can fold into a relatively compact structure for storage yet which is easily opened for erection on a support surface for use.

A further object of the present invention is to provide a folding support stand for plants that is adjustable during use.

A further object of the present invention is to provide a folding support stand for plants that is sturdy in construction so as to support heavy plants and fruits.

Still a further object of the present invention is to provide a support stand for plants that is simply and inexpensive in construction.

According to the present invention, then, a folding support stand adapted for use with plants is provided. The folding support stand includes a first support frame that has a first pair of first and second legs spaced apart from one another and interconnected by at least one first beam member to define a first open region therebetween. A second support frame includes a second pair of first and second legs spaced apart from one another and interconnected by at least one second beam member to define a second open region therebetween. At least one trellis piece is disposed on the first support frame and extends across the first open region, and at least one trellis piece is disposed on the second support frame and extends across the second open region.

The first and second support frames are pivotally connected to one another about a pivot axis for movement between a closed position wherein the first and second support frames generally confront one another and an open position wherein the first and second support frames are at an acute angle with respect to one another. To this end, then, each first leg is pivotally connected to an associated second leg by an axle pin at a pivot axis so as to define a scissor assembly with these scissor assemblies, then, being interconnected by the beam members. A catch assembly is then provided and is associated with the first and second support frames such that, in a fastened state, the catch assembly restrains relative movement of the first and second support frames past the open position.

In the disclosed embodiments, each support frame includes a pair of spaced apart first beam members, and the second support frame includes a pair of spaced apart second beam members so that each of the support frames is generally rectangular in configuration with a rectangular open region. In one embodiment, each support frame is shown to have two horizontal trellis pieces, in the form of slats, with the trellis pieces connected at opposite ends to the first and second legs of the respective support frame. Auxiliary trellis pieces, also slats, extend between the upper and lower beam members. In another embodiment, the trellis pieces include a primary plant support formed as a spine that is serpentine in configuration. Secondary plant supports extend laterally of the spine and are configured as leaf-like elements.

The catch assembly is disclosed to be adjustable whereby the acute angle of the support frame when in the open position is selectively variable. For example, the catch assembly can include a chain interconnectable between the first and second support frames. A link of the chain is then adapted to engage hooks on the frames so that, depending on the selected link, the length of the chain can be varied to adjust the angle of the open position. Alternatively, a chain can be fastened at one end to the trellis piece of one of the first and second support frames and a hook disposed on the trellis piece of another of the first and second support frames. In the exemplary embodiment, a pair of catch assemblies are provided with each of these catch assemblies being associated with the respective support frame.

The legs forming each scissor assembly are pivotally connected by axle pins so as to have an upper leg section on one side of the axle pin and a lower leg section on the other side of the respective axle pin. Here, the beam members are interconnected across the upper leg sections with the upper leg sections being longer in length than the lower leg sections.

These and other objects of the present invention will become more readily appreciated and understood from a consideration of the following detailed description of the exemplary embodiment of the present invention when taken together with the accompanying drawings, in which:

### BRIEF DESCRIPTION OF THE DRAWINGS

FIG. 1 is a perspective view of the folding support stand for plants according to a first exemplary embodiment of the present invention shown in an open position;

FIG. 2 is an end view in elevation of the folding support stand for plants according to the first exemplary embodiment of the present invention shown in a closed position;

FIG. 3 is an end view in elevation of the folding support stand for plants according to the first exemplary embodiment of the present invention shown in an open position;

FIG. 4 is a side view in elevation of the folding support stand for plants according to the first exemplary embodiment of the present invention shown in a closed position;

FIG. 5 is a backside view in elevation of a representative support frame used with the folding support stand of FIGS. 1-4;

FIG. 6 is a front side view in elevation of the support frame shown in FIG. 5;

FIG. 7 is a back view in elevation of a second exemplary embodiment of a representative support frame according to the present invention;

FIG. 8 is a perspective view of the folding support stand for plants according to a third exemplary embodiment of the present invention;

FIG. 9 is a side view in elevation of a representative support frame used with the folding support stand of FIG. 8;

FIG. 10 is an exploded view in perspective showing an upper portion of a representative support frame according to the third exemplary embodiment of the present invention;

FIG. 11 is an end view in elevation showing the folding support stand of FIG. 8 in a closed position;

FIG. 12 is an end view in elevation showing the folding support stand of FIGS. 8 and 9 in an open position; and

FIG. 13 is a cross-sectional view taken about lines 13-13 of FIG. 12.

### DETAILED DESCRIPTION OF THE EXEMPLARY EMBODIMENTS

The present invention broadly relates to gardening apparatus. In particular, the present invention concerns a support stand that may be used for plants, such as vines, climbing plants and the like. The support stand of the present invention folds between a closed position for storing and an open position for use. Broadly, then, it includes a pair of support frames that are pivotally attached to on another but which is provided with a catch assembly or mechanism in order to retain the pair of support frames in the open position during use.

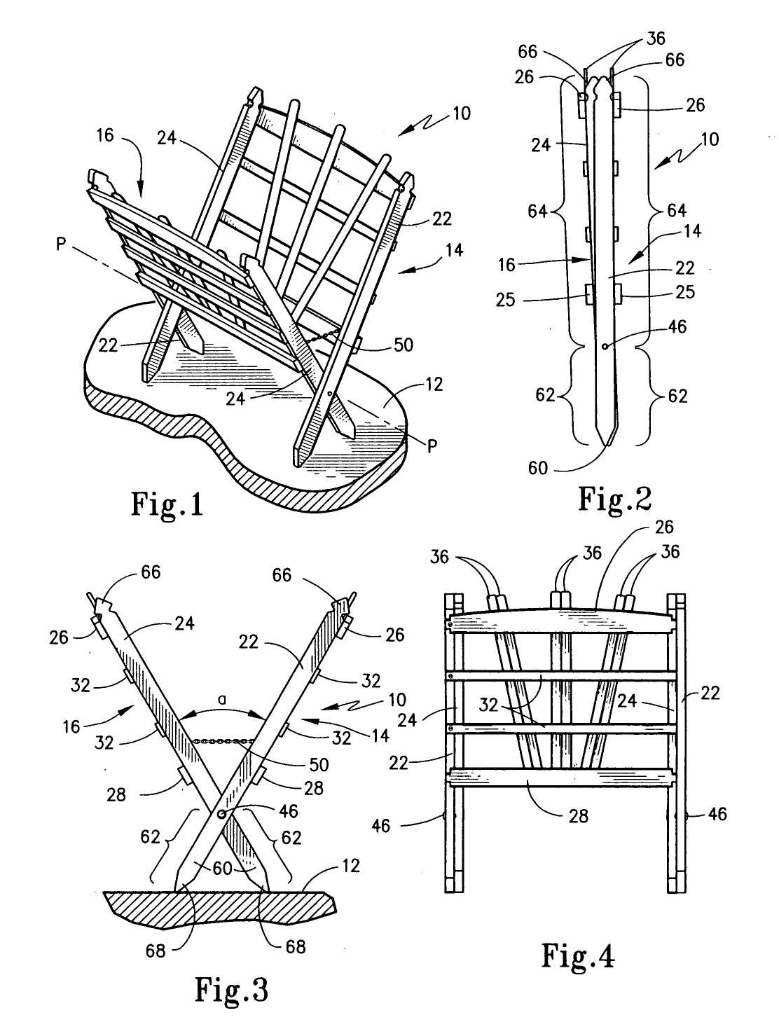

With reference first to FIGS. 1-4, it may be seen that a folding support stand 10 according to the exemplary embodiment of the present invention includes a first support frame 14 and a second support frame 16 which are pivotally attached to one another so that they may pivot relative to one another about a pivot axis “P”. Support stand 10 is shown in FIGS. 1 and 3 in an open position and an erected state on a support surface 12 such as the ground. Support stand 10 is shown in a closed position in FIGS. 2 and 4.

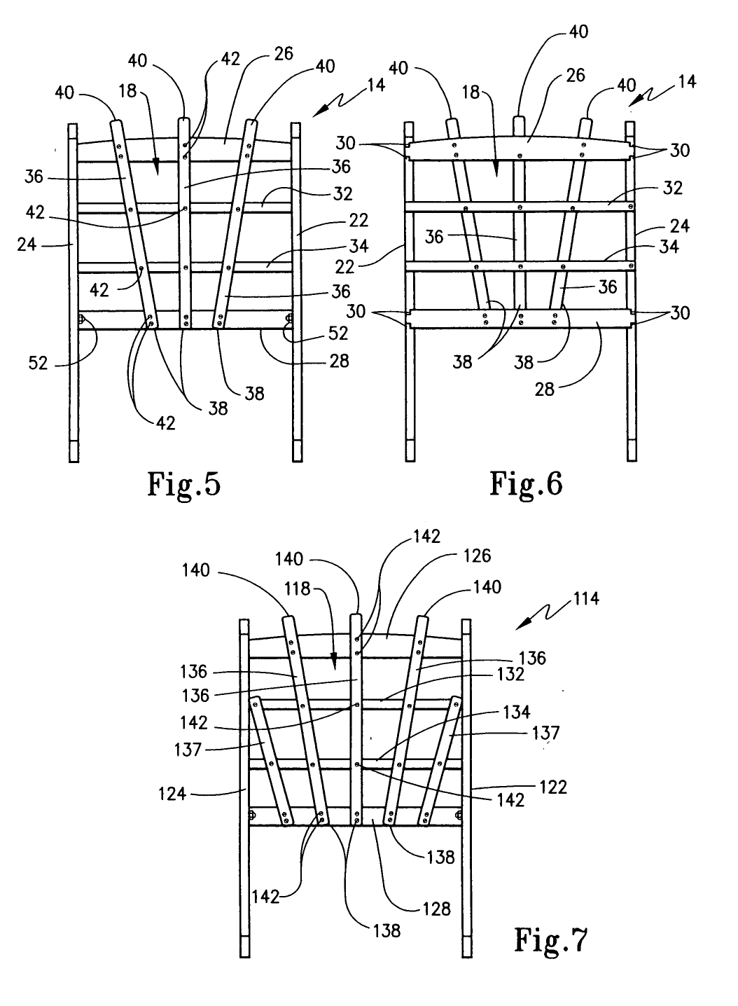

With reference now to FIGS. 5 and 6, a representative support frame, such as support frame 14, is illustrated. To this end, it should be appreciated that each of support frames 14 and 16 may be identically constructed so that a discussion of the structure of support frame 14 shown in FIGS. 5 and 6 suffices also for a description of support frame 16. As is shown in FIGS. 5 and 6, support frame 14 includes a pair of legs 22 and 24 which are in spaced apart parallel relation to one another and are fastened to one another by means of an upper beam member 26 and a lower beam member 28. Beam members 26 and 28 are in spaced apart parallel relationship to one another so that support frame 14 (and support frame 16) has a generally rectangular open region bounded by the legs and the beam members. Beams 26 and 28 are fastened by means of screws 30 or other suitable fasteners which can extend through suitable bores and threaded openings. Legs 22 and 24 as well as beam members 26 and 28 may be constructed of any convenient material, such as wood, plastic, composites, metal, etc.

At least one, but preferably two horizontal trellis pieces 32 and 34 are located in spaced-apart, generally parallel relation to one another and extend between legs 22 and 24 so as to extend across the open region 18 and are located in spaced relation between beams 26 and 28. Each of trellis pieces 32 and 34 are constructed of wood, metal, plastic and the like, and trellis pieces 32 and 34 are here formed as slats of smaller dimension then the legs and the beam members. As illustrated, each trellis piece 32 and 34 are also generally parallel to beams 26 and 28.

Each trellis piece 32 and 34 defines a primary plant support for the folding support stand 10. To this end, also, upright trellis pieces 36 extend between beams 26 and 28 and form additional plant supports that are oriented transversely to trellis pieces 32 and 34. Each of upright trellis pieces 36 are fastened to beams 26 and 28 and to horizontal trellis pieces 32 and 34 by screws 42 or other convenient fasteners, such as nails, adhesives, etc. As may also be seen in FIGS. 5 and 6, lower ends 38 of trellis pieces 36 are closer together than upper ends 40 so that the array of trellis pieces 36 is somewhat fan-shaped in configuration. Each of trellis pieces 36 are formed as slats similar to trellis pieces 32 and 34, and trellis pieces 36 provide auxiliary trellis support for a growing plant.

With reference to FIGS. 1-4, it may be seen that the first leg 22 of one support frame is pivotally connected to second leg 24 of the second support frame by and axle pin 46. Likewise, the second leg 24 of the first support frame is interconnected to a first leg 22 of the second support frame for pivotal motion by another axle pin 46. To this end, respective pairs of first and second legs define first and second scissor assemblies so that support frames 14 and 16 may pivot relative to one another on axle pins 46 between the closed position shown in FIGS. 2 and 4 and an open position shown in FIGS. 1 and 3. When in the open position, support frames 14 an 16 are oriented at a large acute angle “a”. Acute “a” may be in a range of about 45 to 75 degrees, but as is illustrated in FIG. 3, is about 60 degrees. When in the closed position, support frames 14 and 16 generally confront one another, as is illustrated in FIG. 2.

In order to hold frames 14 and 16 in the desired open position, a catch assembly is associated with the first and second support frames and is operative in a fastened state to restrain relative movement of first and second support frames 14 and 16 past the open position. While a variety of catch assemblies may be used as should be appreciated by the ordinarily skilled person in this field of invention, the illustrated catch assembly according to the exemplary embodiment is in the form of a pair of chains 50 that extends between each set of legs 22, 24 as illustrated in FIG. 3. Preferably, two such chain pieces 50 are provided. To this end, as is best illustrated in FIG. 5, each leg 22, 24 is provided with a hook element 52. The hook elements 52 are located proximately to the junction of beam 28 and the respective leg 22, 24. Each chain 50 has links that are able to engage a respective hook element 52 so that, as support frames 14 and 16 are pivoted into the open position, chains 50 prevent opening the frames beyond the open position since they are placed in tension. To this end, also, it should be appreciated that, by selecting which links of the chains engage the hooks, the catch assembly is adjustable so that the acute angle “a” may be selectively variable.

With reference again to FIGS. 2 and 3, it may be seen that each of legs 22 and 24 has a lower leg section 62 on one side of the pivot axis “P” that is defined by axle pin 46. This lower leg section 62 extends between pivot axis “P” and the lower end portion 60 of the respective leg. Similarly, each of the 22 and 24 include an upper leg section 64 that extends between the pivot axis “P” as defined by axle pin 46, and an upper end portion 66 of the respective leg 22, 24. The lower leg sections 62 are shown to be shorter than upper leg sections 64 so that, when support frames 14 and 16 are pivoted into the open position, end portions 60 are closer together than end portions 66. As can also be seen in FIGS. 2 and 3, upper beam members 26 are located proximately to the upper end 66 of each of its respective first and second legs while the lower beam members 28 extend between upper leg sections 64 proximately to the pivot axis “P”. Moreover, end portion 60 of each of the first and second legs 22 and 24 has a lower end 68 formed as a piecing tip to facilitate penetration into the ground.

In the foregoing, it may be seen that each of support frames 14 and 16 is constructed identically to one another so as to have a pair of spaced apart legs interconnected by a pair of spaced apart beams so as to be rectangular in shape with a rectangular open region 18 located therein. A plurality of trellis pieces 32 and 34 are then provided to extend across open region 18 (FIG. 2) so as to provide a plurality of primary plant supports and a plurality of auxiliary plant supports in the form of upright trellis pieces 36. In this manner, climbing vines may climb around each support frame and be supported by beams 26 and 28 as well as trellis pieces 32, 34 and 36.

The catch assembly provided by chain 50 may be attached to hook elements 52 as desired to control the angle “a” to define the angle “a” that the scissor frameworks may open. When not in use, the support frames may be pivoted into confronting relationship (FIGS. 2 and 4) for storage. When it is desired to use the support stand 10, the support stand is placed in a desired location and opened to the open position (FIGS. 1 and 3) typically in proximally to or surrounding a plant to be supported thereby. The support stand 10 therefore provides a suitable support frame that is generally ordered in an upright manner for climbing vines or other plants. This support stand is both substantially sturdy as well as decorative for use in gardens and landscaping applications.

With reference next to FIG. 7, a second exemplary embodiment of a support frame 114 is illustrated. It should be understood that, in order to construct a plant support according to the present invention, two such support frames 114 are required, but they may be constructed identically, as was the case with support frames 14 and 16 discussed above. Moreover, the pair of frames 114 would be connected to each other in the same manner as in the first exemplary embodiment, so that such construction need not be repeated here.

The difference between support frame 114 and support frame 14 resides in the size and orientation of the upright trellis pieces. As depicted in FIG. 7, support frame 114 has a pair of legs 122 and 124 that are in parallel spaced-apart relation to one another and interconnected to one another by beams 126 and 128. Spaced primary trellis pieces 132 and 134 again extend across open region 118 generally parallel to each other and to beams 126 and 128. First upright trellis pieces 136 extend between beams 126 and 128 and form additional plant supports. Each of upright trellis pieces 136 are fastened to beams 126 and 128 and to horizontal trellis pieces 132 and 134 by screws 142 or other convenient fasteners, such as nails, adhesives, etc. As may also be seen in FIG. 7, lower ends 138 of trellis pieces 136 are closer together than upper ends 140 so that the array of trellis pieces 36 is somewhat fan-shaped in configuration. Here, however, a pair of shorter upright trellis pieces 137 are provided with one trellis piece 137 located on each side of the array of trellis pieces 136. Trellis pieces 137 extend between lower beam 128 and horizontal trellis piece 132.

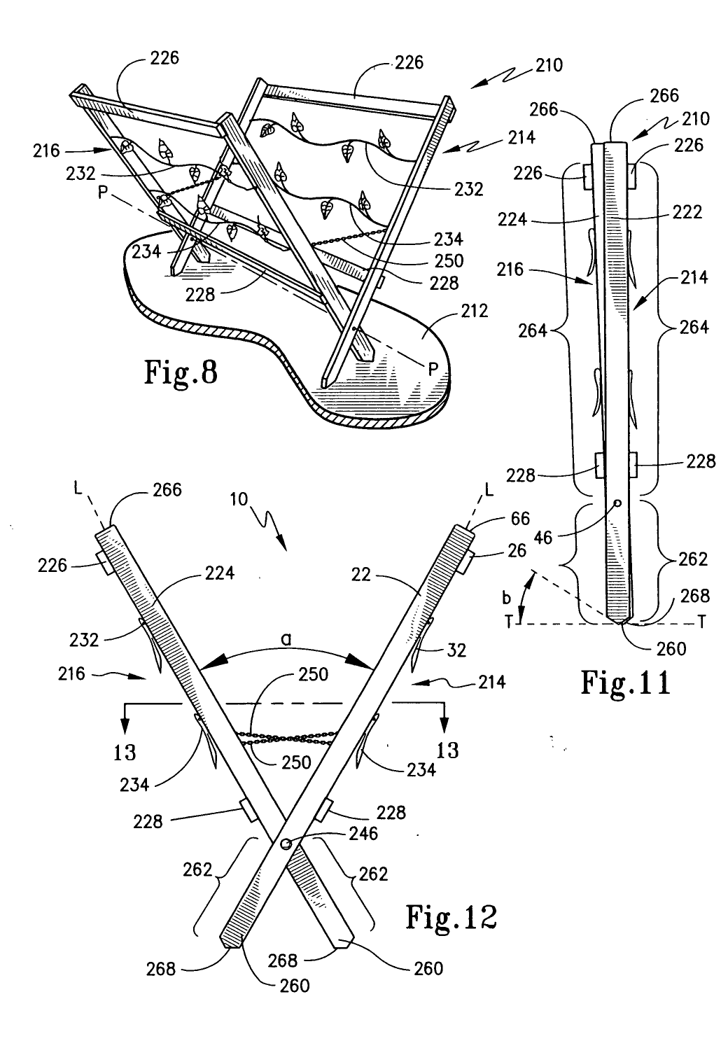

With reference now to FIGS. 8-13, a third exemplary embodiment of the present invention is illustrated. In FIG. 8, it may be seen that a folding support stand 210 according to the third exemplary embodiment of the present invention is shown in an open position and an erected state on a support surface 212 such as the ground. Support stand 210 includes a first support frame 214 and a second support frame 216 which are pivotally attached so that they may pivot relative to one another about a pivot axis “P”.

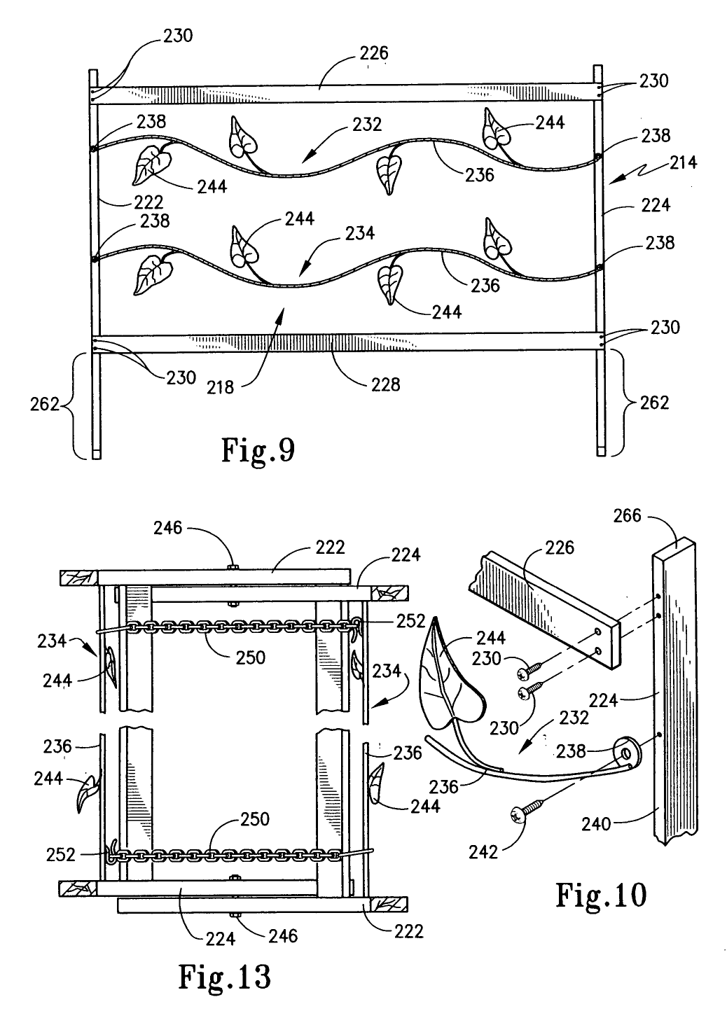

With reference now to FIGS. 9 and 10, a representative support frame for this embodiment, here designated as support frame 214, is illustrated. To this end, it should be appreciated that each of support frames 214 and 216 may be identically constructed so that a discussion of the structure of support frame 214 shown in FIGS. 9 and 10 suffices also for a description of support frame 216. As is shown in FIGS. 9 and 10, support frame 214 includes a pair of legs 222 and 224 which are in spaced apart parallel relation to one another and are fastened to one another by means of a pair of upper and lower beam members 226 and 228 that are in spaced apart parallel relationship to one another. Again, support frame 214 (and support frame 216) has a generally rectangular open region bounded by the legs and the beam members. Beams 226 and 228 are fastened by means of screws 230 or other suitable fasteners which can extend through suitable bores and threaded openings. Legs 222 and 224 as well as beam members 226 and 228 may be constructed of any convenient material, such as wood, plastic, composites, metal, etc.

At least one, but preferably two trellis pieces 232 and 234 are located in spaced apart relation to one another and extend between legs 222 and 224 so as to extend across the open region 218. and are located in spaced relation between beams 226 and 228. Each of trellis pieces 232 and 234 are constructed of metal, plastic and the like. As illustrated, each trellis piece 232 and 234 include a spine 236 that is serpentine in configuration, as is shown in FIG. 9. An annular washer element 238 is affixed to each end of a respective spine 236 so that spine 236 may be secured to an edge surface 240 of a respective leg 222, 224, again by means of a screw, such as screw 242, or other fastener.

Each spine 236 thus defines a primary plant support for the folding support stand 210. To this end, also, each trellis piece 232, 234 includes a secondary plant support that extends laterally of the spine 236. In the embodiment shown in FIGS. 8-12 the secondary plant supports are configured as decorative elements, such as leaf-like elements 244 which are fixed to spine 236. It should be understood, however, that the trellis pieces 232 and 234 could extend between beams 226 and 228 and still provide support for a growing plant.

With reference to FIG. 13, it may be seen that the first leg 222 of one support frame is pivotally connected to second leg 224 of the second support frame by and axle pin 246. Likewise, the second leg 224 of the first support frame is interconnected to a first leg 222 of the second support frame for pivotal motion by another axle pin 246. To this end, respective pairs of first and second legs define first and second scissor assemblies so that support frames 214 and 216 may pivot relative to one another on axle pins 246 between a closed position shown in FIG. 11 and an open position shown in FIG. 12. When in the open position, support frames 214 and 216 are oriented at a large acute angle “a”. Acute “a” may be in a range of about 45 to 75 degrees, but as is illustrated in FIG. 12, is about 60 degrees. When in the closed position, support frames 214 and 216 generally confront one another, as is illustrated in FIG. 11.

In order to hold frames 214 and 216 in the desired open position, a catch assembly is associated with the first and second support frames and is operative in a fastened state to restrain relative movement of first and second support frames 214 and 216 past the open position. The illustrated catch assembly according to the exemplary embodiment is in the form of a chain 250 that extends between the two trellis pieces 234. Preferably, two such chain pieces 250 are provided and extend between trellis pieces 234 at a location proximate to legs 222 and 224 within the regions bounded thereby. To this end, as is best illustrated in FIG. 13, each chain 250 is fastened at one end to spine 236 of trellis piece 234 of one of the support frames and a hook element 252 is affixed on the trellis piece 234 on the other of the support frames. The hook elements 252 are located at an end portion of the spine 236. Chain 250 has links that are able to engage a respective hook element 252 so that, as support frames 214 and 216 are pivoted into the open position, chains 250 prevent opening the frames beyond the open position since they are placed in tension. To this end, also, it should be appreciated that the catch assembly is adjustable so that the acute angle “a” may be selectively variable.

With reference again to FIGS. 11 and 12, it may be seen that each of legs 222 and 224 has a lower leg section 262 on one side of the pivot axis “P” that is defined by axle pin 246. This lower leg section 262 extends between pivot axis “P” and the lower end portion 260 of the respective leg. Similarly, each of the 222 and 224 include an upper leg section 264 that extends between the pivot axis “P” as defined by axle pin 246, and an upper end portion 266 of the respective leg 222, 224. The lower leg sections 262 are shown to be shorter than upper leg sections 264 so that, when support frames 214 and 216 are pivoted into the open position, end portions 260 are closer together than end portions 266. As can also be seen in FIGS. 11 and 12, upper beam members 226 is located proximately to the upper end 260 of each of its respective first and second legs while the lower beam members 228 extend between upper leg sections 264 proximately to the pivot axis “P”. Moreover, end portion 260 of each of the first and second legs 222 and 224 has a lower end 260 including a contact face 268 that is oriented obliquely to the longitudinal axis “L” thereof. Preferably, these faces are formed at an acute angle “b” with respect to a transverse axis “T” that is orthogonal to the longitudinal axis “L”. The angle “b” may be selected such that, when the support stand 210 is moved to the open position, contact faces 268 are in a confronting, somewhat parallel relationship to the support surface 212.

In the foregoing, it may be seen that each of support frames 214 and 216 are constructed identically to one another so as to have a pair of spaced apart legs interconnected by a pair of spaced apart beams so as to be rectangular in shape with a rectangular open region 218 located therein. A plurality of trellis pieces 232 and 234 are then provided to extend across open region 218 (FIG. 9) so as to provide a plurality of primary plant supports in the form of serpentine spines 236 and a plurality of secondary plant supports in the form of leaf elements 244. In this manner, climbing vines may climb around each support frame and be supported by beams 226 and 228 as well as trellis pieces 232 and 234.

The catch assembly provided by chain 250 may be attached to hook elements 252 as desired to control the angle “a” to define the angle “a” that the scissor frameworks may open. When not in use, the support frames may be pivoted into confronting relationship (FIG. 11) for storage. When it is desired to use the support stand 210, the support stand is placed in a desired location and opened to the open position (FIGS. 8 and 12) typically in proximally to or surrounding a plant to be supported thereby. The support stand 210 therefore provides a suitable support frame that is generally ordered in an upright manner for climbing vines or other plants. This support stand is both substantially sturdy as well as decorative for use in gardens and landscaping applications.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A folding support stand for plants, comprising:
(A) a first support frame including a first pair of first and second legs positioned in spaced apart from one another and interconnected by at least one beam member to define a first open region therebetween;
(B) a second support frame including a second pair of first and second legs spaced apart from one another and interconnected by at least one beam member to define a second open region therebetween, said first and second support frames being pivotally connected to one another at a pivot axis for movement between a closed position wherein said first and second support frames generally confront one another and an open position wherein said first and second support frames are at an acute angle with respect to one another;
(C) at least one first trellis piece disposed on and supported by said first support frame and extending across the first open region;
(D) at least one second trellis piece disposed on and supported by said second support frame and extending across the second open region; and
(E) a catch assembly associated with said first and second support frames and operative in a fastened state to restrain relative movement thereof past the open position.

2. A folding support stand according to claim 1 wherein each of said first and second trellis pieces is formed as a slat extending between said first and second legs.

3. A folding support stand according to claim 2 wherein each of said first and second support frames includes an upright trellis piece extending tranversely to its respective first and second trellis piece.

4. A folding support stand according to claim 3 wherein each of said first and second support frames includes a plurality of upright trellis pieces extending transversely to its respective first and second trellis piece in a fan-shaped configuration.

5. A folding support stand according to claim 1 wherein each said trellis piece includes a primary plant support formed as spine extending between said first and second legs.

6. A folding support stand according to claim 5 wherein said spine is serpentine in configuration.

7. A folding support stand according to claim 5 wherein each said trellis piece includes a secondary plant support extending laterally of said spine.

8. A folding support stand according to claim 7 wherein said secondary plant support is configured as a leaf-like element.

9. A folding support stand according to claim 1 wherein each of said first and second support frames includes a plurality of trellis pieces secured to said first and second legs and extending across the open region.

10. A folding support stand according to claim 1 wherein said catch assembly is adjustable whereby the acute angle of said support frames when in the open position is selectively variable.

11. A folding support stand according to claim 9 wherein said catch assembly includes a hook disposed on each of said first and second support frames and a chain adapted to be secured to said hooks.

12. A folding support stand according to claim 1 including a pair of catch assemblies associated with said first and second support frames and each operative in a fastened state to restrain relative movement thereof past the open position.

13. A folding support stand for plants adapted to be erected on a support surface, comprising:
(A) a first support frame of generally rectangular configuration including
(1) a first pair of elongated first and second legs each extending along a longitudinal axis, the first and second legs of said first pair being generally parallel to one another,
(2) upper and lower beams oriented in spaced-apart generally parallel relation to one another and interconnecting the first and second legs of said first pair to define a first open region bounded by said upper and lower beams and the first and second legs of said first pair, and
(3) at least one first trellis piece disposed on said first support frame and extending across the first open region, and
(B) a second support frame of generally rectangular configuration including
(1) a second pair of elongated first and second legs each extending along a longitudinal axis generally parallel to one another,
(2) upper and lower beams oriented in spaced-apart generally parallel relation to one another and interconnecting the first and second legs of said second pair to define a second open region bounded by said upper and lower beams and the first and second legs of said second pair, and
(3) at least one second trellis piece disposed on said second support frame and extending across the first open region;
(C) the first leg of said first support frame being pivotally connected to the second leg of said second support frame at a first axis and the first leg of said second support frame being pivotally connected to the second leg of said first support frame at a second axis to define a common pivot axis, each of said first and second legs having a lower leg section on one side of the pivot axis and an upper leg section on another side of the pivot axis, said first and second support frames being pivotal about the common axis between a closed position wherein said first and second support frames confront one another and an open position wherein said first and second support frames are at an acute angle with respect to one another; and
(D) a catch assembly associated with said first and second support frames and operative in a fastened state to restrain relative movement thereof past the open position.

14. A folding support stand according to claim 13 wherein said first and second support frames are pivotally connected by an axle pin pivotally connecting each said first leg to a respective said second leg.

15. A folding support stand according to claim 13 wherein said lower leg sections are shorter than said upper leg sections.

16. A folding support stand according to claim 13 including a pair of first trellis pieces each extending between said pair of said first and second legs and a pair of second trellis pieces extending between said second pair of said first and second legs.

17. A folding support stand according to claim 16 including a plurality of first auxiliary trellis pieces extending between the upper and lower beams of said first support frame and a plurality of second auxiliary trellis pieces extending between the upper and lower beams of said second support frame.

18. A folding support stand according to claim 13 wherein each of said first and second support frames includes a plurality of trellis pieces extending across the open region thereof.

19. A folding support stand according to claim 13 wherein said catch assembly is adjustable whereby the acute angle of said support frames when in the open position is selectively variable.

20. A folding support stand according to claim 13 wherein each of said upper beams is located proximately to an upper end of its respective said first and second legs and wherein each of said lower legs extends between said upper leg sections proximately to the common pivot axis.

21. A folding support stand according to claim 13 wherein each of said first and second legs has lower ends having a contact face oriented obliquely to the respective longitudinal axis thereof.

22. A folding support stand according to claim 13 including a pair of catch assemblies associated with said first and second support frames and each operative in a fastened state to restrain relative movement thereof past the open position.

23. A folding support stand for plants adapted to be erected on a support surface, comprising:
(A) a first scissor assembly formed by a first pair of first and second legs pivotally secured to one another at a first pivot axis, each of said first pair of first and second legs having an upper leg section on one side of the first pivot axis and a lower leg section on another side of the first pivot axis;
(B) a second scissor assembly formed by a second pair of first and second legs pivotally secured to one another at a second pivot axis, each of said second pair of first and second legs having an upper leg section on one side of the second pivot axis and a lower leg section on another side of the second pivot axis;
(C) at least one first beam member interconnecting the upper leg section of the first leg of said first scissor assembly to the upper leg section of the second leg of said second scissor assembly in spaced apart relation to one another to define a first support frame having a first open region;
(D) at least one second beam member interconnecting the upper leg section of the second leg of said first scissor assembly to the upper leg section the first leg of said second scissor assembly in spaced apart relation to one another to define a second support frame having a second open region, said first and second support frames pivotally movably with respect to one another between a closed position wherein said first and second support frames generally confront one another and an open position wherein said first and second support frames are at an acute angle with respect to one another;
(E) at least one first trellis piece disposed on said first frame and extending across the first open region;
(F) at least one second trellis piece disposed on said second frame and extending across the second open region; and
(G) a catch assembly associated with said first and second frames and operative in a fastened state to restrain relative movement thereof past the open position.

24. A folding support stand according to claim 23 including a plurality of first beam members interconnecting the upper leg section of the first leg of said first scissor assembly to the upper leg section of the second leg of the second scissor assembly and a plurality of second beam members interconnecting the upper leg section of the second leg of said first scissor assembly to the upper leg section of the first leg of said second scissor assembly, said first beam members being in spaced apart relation to one another and said second beam members being in spaced apart relation to one another.

25. A folding support stand according to claim 24 including a plurality of spaced apart first trellis pieces extending between the upper leg section of the first leg of said first scissor assembly and the upper leg section of the second leg of the second scissor assembly between said first beam members, and including a plurality of spaced apart second trellis pieces extending between the upper leg section of the second leg of the first scissor assembly and the upper leg section of the first leg of said second scissor assembly between said second beam members.

26. A folding support stand according to claim 25 including a plurality of auxiliary trellis pieces extending between said first beams and including a plurality of auxiliary trellis pieces extending between said second beams.

27. A folding support stand according to claim 23 wherein said catch assembly is adjustable whereby the acute angle of said support frames when in the open position is selectively variable.

28. A folding support stand according to claim 23 wherein said upper leg sections are longer than said lower leg sections.
